(19) United States
(12) Patent Application Publication
(10) Pub. No.: US 2024/0330906 A1
(43) Pub. Date: Oct. 3, 2024

(54) TOKEN STANDARD IMPLEMENTATION FOR TOKENIZED SECURITIES

(71) Applicant: COSMIC WIRE, Marina Del Rey, CA (US)

(72) Inventors: Mark Ellis, Prescott, AZ (US); Jerad Finck, Marina Del Ray, CA (US); Mike Mumola, Kearny, NJ (US); Greg Parker, Bethlehem, CT (US)

(21) Appl. No.: 18/620,769

(22) Filed: Mar. 28, 2024

Related U.S. Application Data
(60) Provisional application No. 63/455,205, filed on Mar. 28, 2023.

(51) Int. Cl. G06Q 20/36

(52) U.S. Cl. CPC G06Q 20/3678; G06Q 2220/00

(57) ABSTRACT

Techniques for enforcing transfer restrictions on a regulated securities token include configuring, an account associated with a cryptocurrency wallet to receive a securities token by setting one or more transfer restrictions based in part on one or more identified characteristics associated with the account. Requests to transfer the securities token to a recipient account associated with a regulated transfer group are managed.

### CROSS-REFERENCE TO RELATED APPLICATIONS

This patent application claims priority to U.S. Provisional Patent Application Ser. No. 63/455,205, filed on Mar. 28, 2023, entitled “TOKEN STANDARD IMPLEMENTATION FOR TOKENIZED SECURITIES”, which is herein incorporated by reference in its entirety.

### TECHNICAL FIELD

The present disclosure generally relates to blockchain and cryptocurrency technologies, and more specifically, to techniques for implementing a token standard protocol for tokenized securities.

### BACKGROUND

Blockchain enables financial assets such as stocks, bonds, real estate, or commodities to be digitally represented as tokens. The tokens represent ownership or rights to the underlying asset and may be bought, sold, or traded by individuals. These tokenized securities may provide for increased liquidity, fractional ownership, and shorter settlement times.

Enforcing regulatory compliance with tokenized securities is a known issue. Currently, no standardized approach for enforcing transfer restrictions for groups (e.g., Regulation S groups, Regulation D groups, United States-accredited investors, etc.) exists. Some preexisting approaches add unnecessary complexity for simple use cases and thus have not reached mass adoption. Therefore, an approach that balances simplicity with sufficiency for regulatory compliance is desired.

### SUMMARY

Embodiments presented herein disclose a token standard implementation for tokenized securities. One embodiment of the present disclosure provides a method. The method generally includes configuring an account associated with a cryptocurrency wallet to receive a securities token with one or more transfer restrictions based in part on one or more identified characteristics associated with the account. The method also generally includes managing requests to transfer the securities token to a recipient account associated with a regulated transfer group.

Another embodiment of the present disclosure provides a system having one or more processors and a memory storing instructions. The instructions, which, when executed on the one or more processors, causes the system to configure an account associated with a cryptocurrency wallet to receive a securities token, in which the account is configured with one or more transfer restrictions based in part on one or more identified characteristics associated with the account. Requests to transfer the securities token to a recipient account associated with a regulated transfer group are managed.

Yet another embodiment of the present disclosure includes a computer-readable storage medium storing a plurality of instructions. The instructions, when executed on one or more processors of a computing system, cause the computing system ot configure an account associated with a cryptocurrency wallet to receive a securities token, in which the account is configured with one or more transfer restrictions based in part on one or more identified characteristics associated with the account. Requests to transfer the securities token to a recipient account associated with a regulated transfer group are managed.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates a decentralized computing environment in which a protocol for enforcing transfer restrictions for tokenized securities is executed, according to an embodiment;

FIG. 2 illustrates a flow diagram for deploying a securities token in the example decentralized computing environment, according to an embodiment;

FIG. 3 illustrates a sequence diagram for enforcing transfer restrictions for a securities token deployed in the example decentralized computing environment, according to an embodiment; and

FIG. 4 illustrates a block diagram of a computing system configured to perform the functions described herein, according to an embodiment.

### DETAILED DESCRIPTION

Embodiments of the present disclosure provide a token standard implementation for tokenized securities. More particularly, the present disclosure provides techniques for enforcing transfer restrictions to regulated groups for compliance with financial regulatory bodies such as the United States Securities and Exchange Commission (SEC). The techniques balance simplicity and sufficiency for smart contract-based securities tokens without adding unnecessary complexity for simple use cases. Further, the techniques account for restrictions by preexisting token standards, such as various Ethereum Request for Comment (ERC) standards (e.g., ERC-20, ERC-1404, etc.) as well as non-standardized ERC guidance. Advantageously, the embodiments of the present disclosure ensure that the full operations of a given smart contract securities token are clear to users associated with the smart contract.

The present disclosure may leverage decentralized blockchain technology. In an embodiment, a blockchain network platform may provide smart contract and administration services that may be used to deploy tokenized securities subject to specified transfer restrictions for regulatory compliance. As also further described herein, tokens may be stored in a blockchain-based data wallet of an individual. In doing so, the data wallet may include functionalities for securely storing securities tokens and transferring tokens to other entities during a buy, sell, or trade transaction. Managing such securities through blockchain technology provides a transparent ledger for all activity associated with the securities token, therefore allowing for relatively straightforward accounting and auditing.

Advantageously, the techniques disclosed herein provide an decentralized interface for issuers of tokenized securities to manage, via smart contracts, the full life cycle of a given securities token throughout its lifecycle, from assigning an investor wallet address to a respective transfer-restricted group, to issuing a given securities token to the investor wallet address, and to paying out dividends, all the while maintaining compliance with regulatory authorities throughout. Embodiments of the present disclosure remove the need for multiple third-party intermediaries that are otherwise required in traditional paper securities transactions and other tokenized securities approaches, in favor of peer-to-peer securities trading between approved parties, while maintaining compliance with regulatory bodies. By bucketing an investor account (e.g., a wallet address associated with the investor account) into an appropriate transfer restriction group, it can be determined whether a secondary trade is permitted. Further, lock-in periods and geographic restrictions associated with registration exemptions are hardcoded into a given securities token under this approach, ensuring compliance throughout the lifecycle of the token.

The techniques described herein also facilitate fundraising under SEC registration exemptions (e.g., exemptions to Reg CF, Reg A+, Reg S, and Reg D groups) and allow traditionally inaccessible markets to be available to a full range of investors, from accredited investors to non-credited investors.

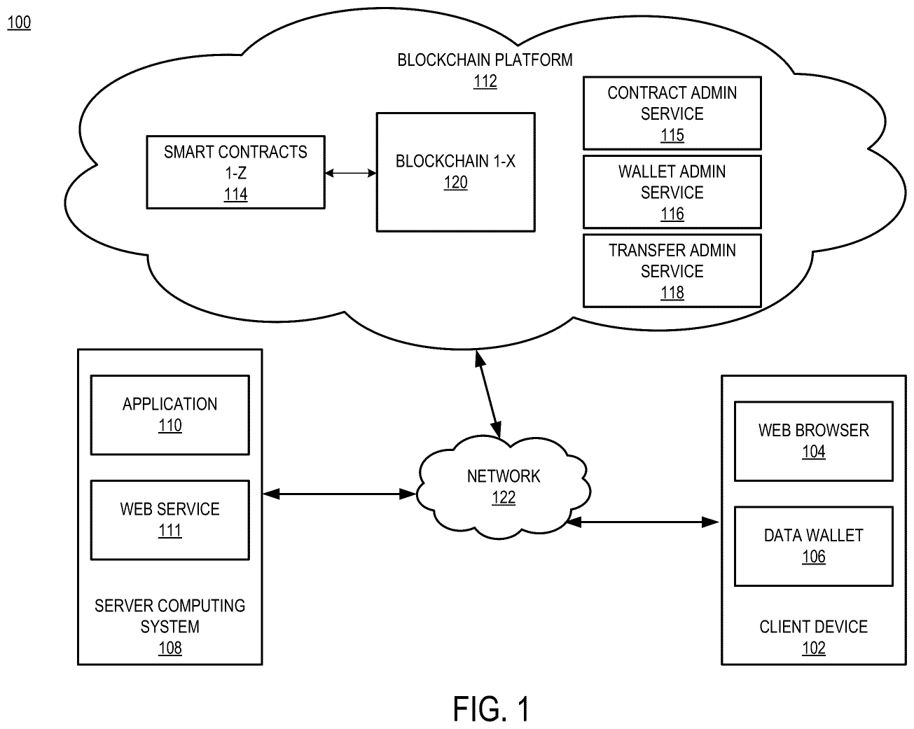

FIG. 1 illustrates an example computing environment 100 in which securities tokens may deployed subject to transfer restrictions. Illustratively, the computing environment 100 includes a client device 102, a server computing system 108, a blockchain platform 112, each interconnected via a network 122 (e.g., the Internet).

The illustrative client device 102 represents a computing system operated by an individual user. The client device 102 may be embodied as any physical computing device (e.g., a desktop computer, laptop computer, workstation, etc.) or a virtual computing device (e.g., a virtual machine instance executing on a physical computing device or on a cloud platform). As shown, the client device 102 includes a web browser 104 and a data wallet 106. The web browser 104 is a software application that accesses content provided by websites over the network 122 and presents the content on a display of the client device 102.

In an embodiment, the data wallet 106 is an client-side interface that provides functions for a user to manage collection, storage, and usage of crypto-based user data and assets, such as cryptocurrency tokens (including tokenized securities), Non-Fungible Token (NFT) data, and the like. The user can also, using the wallet 106, conduct cryptocurrency transfer transactions, in which the cryptocurrency wallet owner may transfer an amount of a specified cryptocurrency funds to a recipient (in which the recipient may be identified through various means, such as by email, telephone number, social media username, etc.), convert an amount of cryptocurrency funds to an amount of funds in another cryptocurrency, and use market data obtained from various sources to ascertain a present conversion rate for a given cryptocurrency. The user may also manage an address book of contacts within a user interface provided by the wallet 106. Doing so simplifies sending and receiving cryptocurrency by allowing users to associate these common identifiers with specific wallet addresses. Traditionally, sending and receiving cryptocurrency requires the use of long and cumbersome public keys or wallet addresses, which is often error prone. The address book disclosed herein provides an intuitive interface for a user to save and manage contact information. With an address book, users can associate their contacts' email addresses, social media handles, or other identifiers with their wallet addresses. This information is then stored in the user's wallet, making it easy to quickly send or receive cryptocurrency without needing to enter long addresses. In an embodiment, the wallet 106 is configured to hide a wallet address during a transaction with a third-party to preserve privacy of the owner of the wallet.

The illustrative server computing system 108 represents one or more computing systems and/or pool of computing resources of an entity providing a server-side interface for the data wallet 106. Each server computing system 108 may be a physical computing device (e.g., a hardware server in a datacenter, a desktop computer, etc.) or a virtual computing instance executing in a cloud network. Illustratively, the server computing system 108 includes an application 110. In an embodiment, the application 110 may execute and draw resources from multiple instances of server computing systems 108. The client device 102 may access the platform via a client application or through a web service 111 accessed through the web browser 104.

The illustrative blockchain platform 112 represents a decentralized immutable ledger peer-to-peer network on which blockchain-based applications and services may execute on a number of computing nodes. In an embodiment, the blockchain platform 112 is an Ethereum Virtual Machine (EVM)-compatible blockchain subnet that is scalable. As shown, the blockchain platform 112 includes a contract admin service 115, wallet admin service 116, and transfer admin service 118. Although FIG. 1 depicts the contract admin service 115, wallet admin service 116, and transfer admin service 118 as separate components, other embodiments may provide each of the services 116 and 118 as a combined service within the blockchain platform 112. The blockchain platform 112 also includes one or more blockchains 1-x 120. Each blockchain 1-x 120 represents a distributed database storing a ledger of transactions that is replicated on each computing node within the platform 112. The one or more blockchains 1-x 120 may be used to store, manage, and execute smart contracts 1-z 114. Each smart contract 1-z 114 may be indicative of a self-executing contract including a number of terms that may be expressed as conditions having associated actions that are executed when the condition is satisfied or otherwise triggered. The contract admin service 115 may generate and configure the smart contract 1-z 114 (e.g., setting parameters and provisions for a given smart contract). The wallet admin service 116 facilitates user actions on the data wallet 106 within the blockchain platform 112 and on the blockchains 1-x 120, such as cryptocurrency and securities token transactions, data storage, and data management.

In an embodiment, one or more smart contracts 1-z may be representative of tokenized securities (also referred to herein as a securities token). A given tokenized securities contract may include functions that generate tokens representing a given securities asset, such as stocks, bonds, real estate, etc, that are subject to an Ethereum Request for Comment (ERC) standard, such as ERC-20. The token securities contract may include owner information, provisions for dividend distribution voter rights, and provisions for regulatory compliance.

As further described herein, the contract admin service 115, wallet admin service 116 and transfer admin service 118 may facilitate requests from a client device 102 to transfer a securities token to another party. More particularly, a given smart contract within the environment may enforce specific administrator roles. The roles divide responsibilities to reduce abuse scenarios. In some embodiments, each role is managed by a separate administrator (e.g., contract admin service 115, wallet admin service 116, transfer admin service 118, and other admin services not shown such as a reserve admin service for initially provisioning and storing the tokens, etc.) with separate private key control. In some cases, a private key for a given role may be managed via a multiple signature approach in which a specified number of approvers are required.

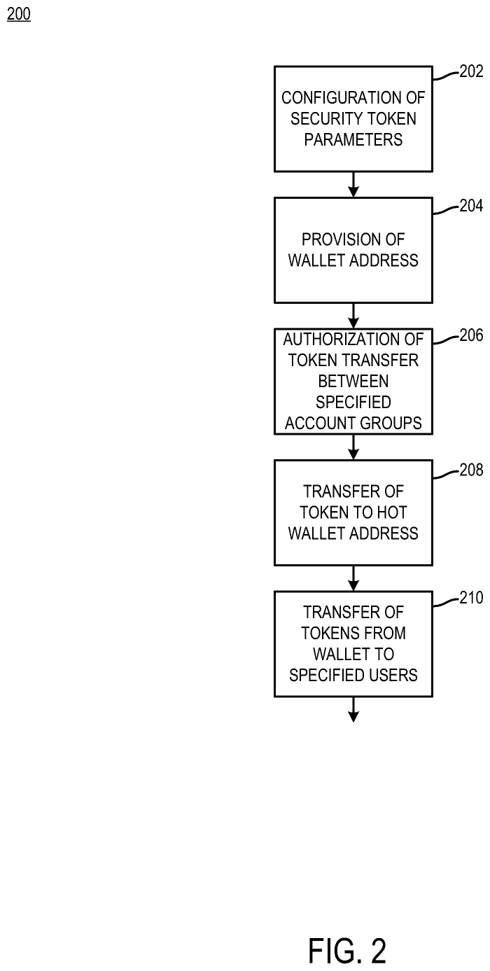

Referring now to FIG. 2, a flow diagram illustrating a method 200 for initially deploying a securities token is shown. At 202, a deploying entity (e.g., an offering entity associated with a given securities asset) may configure parameters associated with the securities asset (e.g., token name and symbol, total amount of tokens representing the securities to be supplied, issuer information, transfer restrictions, compliance and regulatory settings, smart contract functions, ownership rights, access controls, etc.) and deploy the associated smart contract(s) to a public blockchain. At the time of deployment, the deploying entity may configure a separate token reserve address, an address associated with the transfer admin service 118, and an address associated with the wallet admin service 116. Doing so allows reserve security tokens to be stored in cold storage (e.g., due to treasury reserve address private keys not being needed for everyday use by the transfer admin service 118).

At 204, a hot wallet address for distribution of the tokens to investors or other stakeholders may be provisioned, e.g., by a reserve admin service (which may also execute on the blockchain platform 112). In addition, the wallet admin service 116 may set address restrictions, which can include parameters such as investor address information, transfer group information (e.g., information relating to account groups including regulated D (U.S.-accredited investors), S (foreign investors), CF groups, etc.), address time lock specifications, a reserved time locked balance, a maximum amount of tokens, and the like. The address restrictions may be set based on, e.g., identifying characteristics associated with a given transfer group and the restriction associated with those characteristics.

At 206, the transfer admin service 118 may authorize the transfer of tokens between account groups after a given point in time. At 208, the tokens may be transferred (e.g., by the reserve admin service) to the provisioned hot wallet address. The wallet admin service 116 may transfer the tokens to investors or other stakeholders who may be entitled to the tokens.

By default, reserve tokens cannot be transferred. To allow transfers, the transfer admin service 118 may configure transfer rules based on individual accounts and for transfers between accounts in a group. During the setup process, to split transfer oversight across three private key holders, the transfer admin service 118 may configure rules that allow only the reserve admin service to only transfer tokens to the hot wallet address. The hot wallet may be restricted to a limited maximum balance necessary for doing one batch of token distributions (rather than the whole reserve). Using a hot wallet for small balances also makes ordinary token administration simpler without exposing the issuer's reserve of tokens to the risk of total theft in a single transaction. Each private key may also be managed with a multi-signature solution for added security. In some embodiments, the reserve and hot wallet address has its own separate transfer group. In some embodiments, the hot wallet address can transfer to investor groups such as Reg D and Reg S groups.

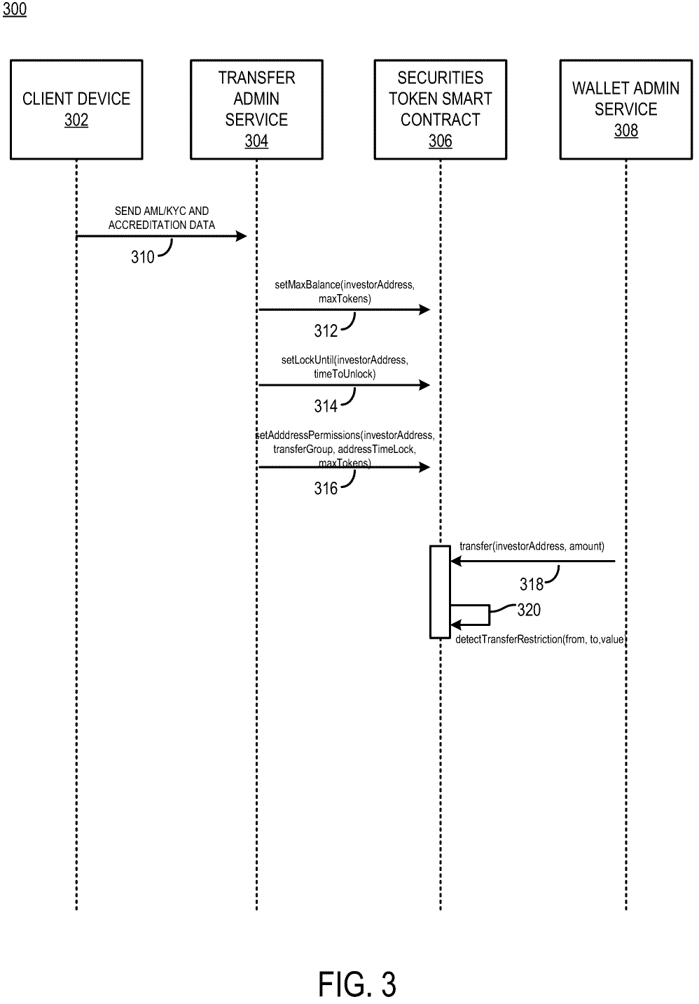

Referring now to FIG. 3, a diagram of a sequence 300 for enforcing transfer restrictions for a securities token is shown. Illustratively, the sequence 300 includes a client device 302 (which may be representative of the client device 102), a transfer admin service 304 (which may be representative of the transfer admin service 118), securities token smart contract 306, and a wallet admin service 308 (which may be representative of the wallet admin service 116). The transfer admin service 304 may provision account addresses to transfer and receive a given securities token smart contract 306 under certain conditions.

At 310, the client device 302 sends compliance credentials, such as anti-money laundering (AML) and/or know your customer (KYC) credentials (e.g., associated with an underlying investor and/or stakeholder who will receive tokens directly from the issuer) to the transfer admin service 304 for verification. Alternatively or in addition, the client device 302 may transmit the AML and/or KYC credentials to a trusted third-party proxy vetting service for verification. Advantageously, doing so avoids needing to store privately identifiable information. A single user may have multiple addresses, though the issuer can track the number of holders and stop authorizing holders when a specified maximum amount of holders is reached. In some embodiments, a securities token allows for metadata pointers to include such AML and KYC verification by the trusted third-party service.

At 312-316, the transfer admin service 304 configures approved blockchain account addresses for the underlying investor and/or stakeholder. For example, at 312, the transfer admin service 304 performs a function to set a maximum token balance for the account address (e.g., setMaxBalance (investorAddress,maxTokens). At 314, the transfer admin service 304 performs a function to set a predetermined lock-in period during which transfer restrictions are to be placed (e.g., setLockUntil (investorAddress,timeToUnlock). At 316, the transfer admin service 304 provisions address permissions for the account of the underlying investor and/or stakeholder relating to specified transfer groups based on the configured lock-in period and maximum token balance (e.g., setAddressPermissions (investorAddress, transferGroup, addressTimeLock, maxTokens). Based on the AML and KYC data and the accreditation process, the client device 302 may provision the account address with a maximum number of tokens, a transfer group designating a regulatory class (e.g., Reg D, Reg CF, Reg S), and a time until which the tokens in the address will be locked. Once provisioned, the wallet admin service 308 is able to transfer a specified amount of tokens to the provisioned account address from the hot wallet of the issuer (transfer (investorAddress, amount). At 318, the wallet admin service 308 initiates a transfer of a token to a specified recipient.

In doing so, at 320, the securities token smart contract 306, in execution, may detect whether transfer restrictions exist (detectTransferRestriction (from,to, value) before authorizing the transfer to the recipient. If transfer restrictions exist, the smart contract 306 may delay transfer of the token(s) until conditions associated with the restrictions are satisfied (e.g., if a configured lock-in period has elapsed). For example, a lock-in period previously configured by the transfer admin service 304 may be detected. Lock-in periods may be enforced in several manners. In an embodiment, all account addresses are locked and require permissions to be transferred. Permissions can be granted on the account level or per address group. In an embodiment, the lock-in period may be enforced based on a UNIX timestamp (in which the UNIX timestamp is indicated as the number of seconds since midnight UTC on Jan. 1, 1970), in which all tokens in an account are locked until the specified time of the UNIX timestamp. In an embodiment, the lock-in period can be applied to all tokens in an account, while in other instances, transfers may be specified as allowed for a specified group of addresses after the timestamp. To allow trading in a group, the transfer admin service 304 may set addressed permissions based on specified groups. A token transfer for an allowed group will succeed if the specified lock-in periods have elapsed and the recipient of the token transfer has not exceeded a specified amount of maximum tokens.

To allow trading between foreign investor groups (e.g., account addresses associated with Reg S groups) but prohibit flow back to U.S. accredited investor groups (e.g., account addresses associated with Reg D groups), the transfer admin service 304 may configure address permissions to restrict settings for Reg S investors, such as by specifying a shorter lock-in period and a given maximum token balance, as well as configure address permissions to restrict settings for Reg D investors to specify a longer lock-in period and a given maximum token balance. A token transfer will succeed if the specified lock-in periods have elapsed and if the recipient of the token transfer does not exceed the maximum balance of tokens for the address.

In an embodiment, centralized exchanges can register custody addresses in the manner of the sequence 300, e.g., by communicating with the issuer to provision accounts, which thereafter the transfer admin service 304 may configure address permissions for the exchange account. When customers of the exchange want to withdraw tokens from the exchange account, they withdraw into an account that the transfer admin service has provisioned based on the address permissions.

In an embodiment, transfers can be paused by the transfer admin service 304 to comply with regulatory action (e.g., if there is a regulatory issue with the token). In some embodiments, transfers may also be paused on invalid forks caused by blockchain forks. Below is an example table of accessible functions between the contract admin service and transfer admin services roles:

| Function | Contract Admin | Transfer Admin |
|---|---|---|
| Pause | Yes | No |
| Unpause | Yes | No |
| grantContractAdmin | Yes | No |
| removeContractAdmin | Yes | No |
| grantTransferAdmin | Yes | No |
| removeTransferAdmin | Yes | No |
| upgradeTransferRules | Yes | No |
| mint | Yes | No |
| Burn | Yes | No |
| Freeze | Yes | Yes |
| setMaxBalance | No | Yes |
| setLockUntil | No | Yes |
| removeLockUntil | No | Yes |
| setTransferGroup | No | Yes |
| setAddressPermissions | No | Yes |
| setAllowGroupTransfer | No | Yes |

In an embodiment, the sequence 300 is adaptable to securities token contracts that include dividend distribution and staking (e.g., with payments in coins like USDC, DAI, ETH, Stablecoin, and ERC-20 tokens). For example, each moment in time is recorded as a snapshot generated by the contract admin service, and payments may be issued as a percentage of balances in the snapshot.

Advantageously, the present disclosure may be further optimized to decrease contract size (and therefore gas burden associated with deploying and managing securities tokens) based on access control. To do so, a binary bitmask may be used to determine access control roles for a given account address. Doing so optimizes gas cost and a size of the smart contract code. A uint8 binary representation of a number may be used to store access controls. To store roles, a specific bit position in the bit storage representation is used. Doing so enables the addition of new roles as well as the assignment of multiple roles (e.g., by adding role number values together to obtain a correct bitmask representation).

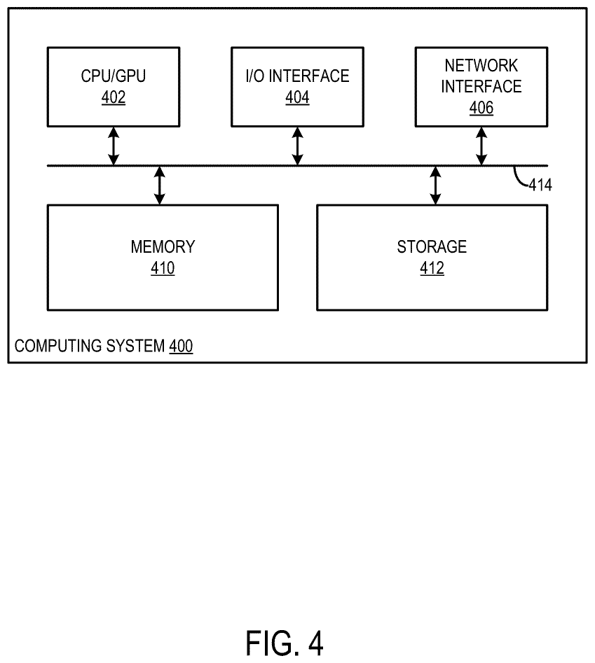

Referring now to FIG. 4, a block diagram of a computing system 400 configured to perform one or more of the functions described herein is shown. For example, the computing system 400 may represent the client device 102, the server computing system 108, or one of the computing nodes within the blockchain platform 102. The computing system 400 includes, without limitation, a central processing unit and/or graphics processing unit (CPU/GPU) 402, an input/output (I/O) interface 404, a network interface 406, a memory 410, and a storage 412, each interconnected via a hardware bus 414. Of course, the actual computing system 400 will include a variety of additional hardware components not shown. Additionally, in some embodiments, one or more of the illustrative components may be incorporated in, or otherwise form a portion of, another component.

The CPU/GPU 402 retrieves and executes programming instructions stored in the memory 410. The CPU/GPU 402 may be embodied as one or more processors, each processor being a type capable of performing the functions described herein. CPU/GPU 402 is included to be representative of a single CPU, multiple CPUs, a single CPU having multiple processing cores, a single GPU, multiple GPUs, a single GPU having multiple processing cores, and/or a combination. For example, the CPU 402 may be embodied as a single or multi-core processor(s), a microcontroller, or other processor or processing/controlling circuit. In some embodiments, the CPU 402 may be embodied as, include, or be coupled to a field programmable gate array (FPGA), an application-specific integrated circuit (ASIC), reconfigurable hardware or hardware circuitry, or other specialized hardware to facilitate performance of the functions described herein. The hardware bus 414 is used to transmit instructions and data between the CPU 402, storage 412, network interface 406, and the memory 410.

The I/O interface 404 allows I/O devices to communicate with hardware and software components of the computing system 400. For example, the I/O interface 404 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O interface 404 may form a portion of a system-on-a-chip (SoC) and be incorporated, along with one or more of the CPU 402, the memory 410, and other components of the computing system 400. The I/O devices may be embodied as any type of I/O device connected with or provided as a component to the computing system 400, such as keyboards, mice, and printers.

The network interface 406 may be embodied as any hardware, software, or circuitry (e.g., a network interface card) used to connect the computing system 400 to other components within the blockchain platform 112 and/or over the network 122. For example, the network interface 406 may be embodied as any communication circuit, device, or collection thereof, capable of enabling communications over the network 122 between the computing system 400 and other devices. The network interface 406 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the network interface 406 may include a network interface controller (NIC, not shown), embodied as one or more add-in-boards, daughtercards, controller chips, chipsets, or other devices that may be used by the computing system 400 for network communications with remote devices. For example, the NIC may be embodied as an expansion card coupled to the I/O interface 404 over an expansion bus such as PCI Express.

The memory 410 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

The storage 412 may be embodied as any type of devices configured for short-term or long-term storage of data such as, for example, memory devices and circuits, memory cards, hard disk drives (HDDs), solid-state drives (SSDs), or other data storage devices. The storage 412 may include a system partition that stores data and firmware code therefor. The storage 412 may also include an operating system partition that stores data files and executables for an operating system.

For the purposes of promoting an understanding of the principles of the present disclosure, reference is made to preferred embodiments and specific language is used to describe the same. It will nevertheless be understood that no limitation of the scope of the disclosure if thereby intended, such alteration and further modifications of the disclosure as illustrated herein, being contemplated as would normally occur to one skilled in the art to which the disclosure relates.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless otherwise defined, all technical terms used herein have the same meaning as commonly understood by one of ordinary skill in the art to which this disclosure belongs.

One aspect of the present disclosure provides a method of enforcing transfer restrictions on securities tokens within a decentralized Internet platform for regulatory compliance. Another aspect of the present disclosure is a system configured to enforce transfer restrictions on securities tokens within a decentralized Internet platform for regulatory compliance. The system can be implemented in hardware, software, firmware, or combinations of hardware, software and/or firmware. In some examples, the system and methods described in this specification may be implemented using a non-transitory computer readable medium storing computer executable instructions that when executed by one or more processors of a computer cause the computer to perform operations. Another aspect of the present disclosure provides all that is described and illustrated herein.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

1. A system comprising:
one or more processors;
a memory storing a plurality of instructions, which, when executed on the one or more processors, causes the system to:
configure an account associated with a cryptocurrency wallet to receive a securities token, wherein the configuration comprises setting one or more transfer restrictions based in part on one or more identified characteristics associated with the account; and
manage requests to transfer the securities token to a recipient account associated with a regulated transfer group.

2. The system of claim 1, wherein the plurality of instructions further causes the system to:
receive compliance credentials associated with the account; and
verify the compliance credentials associated with the account.

3. The system of claim 2, wherein the compliance credentials comprise anti-money laundering (AML) and know your customer (KYC) credentials associated with the account.

4. The system of claim 2, wherein the plurality of instructions further causes the system to:
initiate the transfer of the securities token to the account;
evaluate the one or more transfer restrictions; and
enforce the one or more transfer restrictions.

5. The system of claim 4, wherein the one or more transfer restrictions comprises a transfer group restriction and a lock-in period restriction.

6. The system of claim 5, wherein to enforce the one or more transfer restrictions comprises to enforce the lock-in period based on a UNIX timestamp value.

7. The system of claim 5, wherein to enforce the one or more transfer restrictions comprises to enforce the lock-in period based on the regulated transfer group.

8. One or more computer-readable storage media storing a plurality of instructions instructions, which, when executed by one or more processors of a computing system, causes the computing system to:
configure an account associated with a cryptocurrency wallet to receive a securities token, wherein the configuration comprises setting one or more transfer restrictions based in part on one or more identified characteristics associated with the account; and
manage requests to transfer the securities token to a recipient account associated with a regulated transfer group.

9. The one or more computer-readable storage media of claim 8, wherein the plurality of instructions further causes the system to: 9
receive compliance credentials associated with the account; and
verify the compliance credentials associated with the account.

10. The one or more computer-readable storage media of claim 9, wherein the compliance credentials comprise anti-money laundering (AML) and know your customer (KYC) credentials associated with the account.

11. The one or more computer-readable storage media of claim 9, wherein the plurality of instructions further causes the system to:
initiate the transfer of the securities token to the account;
evaluate the one or more transfer restrictions; and
enforce the one or more transfer restrictions.

12. The one or more computer-readable storage media of claim 11, wherein the one or more transfer restrictions comprises a transfer group restriction and a lock-in period restriction.

13. The one or more computer-readable storage media of claim 12, wherein to enforce the one or more transfer restrictions comprises to enforce the lock-in period based on a UNIX timestamp value.

14. The one or more computer-readable storage media of claim 12, wherein to enforce the one or more transfer restrictions comprises to enforce the lock-in period based on the regulated transfer group.

15. A method comprising:
configuring, by execution of one or more processors on a computing system, an account associated with a cryptocurrency wallet to receive a securities token, wherein the configuration comprises setting one or more transfer restrictions based in part on one or more identified characteristics associated with the account; and
managing requests to transfer the securities token to a recipient account associated with a regulated transfer group.

16. The method of claim 15, further comprising:
receiving compliance credentials associated with the account; and
verifying the compliance credentials associated with the account.

17. The method of claim 16, wherein the compliance credentials comprise anti-money laundering (AML) and know your customer (KYC) credentials associated with the account.

18. The method of claim 16, further comprising:
initiating the transfer of the securities token to the account;
evaluating the one or more transfer restrictions; and
enforcing the one or more transfer restrictions.

19. The method of claim 18, wherein the one or more transfer restrictions comprises a transfer group restriction and a lock-in period restriction and wherein enforcing the one or more transfer restrictions comprises to enforce the lock-in period based on a UNIX timestamp value.

20. The method of claim 19, wherein to enforce the one or more transfer restrictions comprises to enforce the lock-in period based on the regulated transfer group.
